(19) United States
(12) Patent Application Publication
(10) Pub. No.: US 2014/0183210 A1
(43) Pub. Date: Jul. 3, 2014

(54) DISPENSING MECHANISM OF VENDING MACHINE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: PING SUN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/011,960

(22) Filed: Aug. 28, 2013

(30) Foreign Application Priority Data
Dec. 28, 2012 (CN) 2012105820154

(51) Int. Cl. G07F 11/24

(52) U.S. Cl. CPC G07F 11/24
USPC 221/124

(57) ABSTRACT

A dispensing mechanism of a vending machine includes a container and a rotary baffle. The container stores a stack of items vertically and defines a bottom opening and a lateral opening communicating with the bottom opening. The rotary baffle is located at the bottom opening and configured to block the bottom opening. The rotary baffle is rotatable about a horizontal axis. When the rotary baffle is at rest, the rotary baffle supports the items and prevents the items from dropping out of the container. When item delivery is required, the rotary baffle moves through a predetermined angle to drive one item to move out of the lateral opening, which allows the delivery of purchased items individually.

### REFERENCE TO RELATED APPLICATIONS

This application claims all benefits accruing under 35 U.S.C. §119 from China Patent Application No. 201210582297.8 filed on Dec. 28, 2012 in the State Intellectual Property Office of China, the contents of the China Application are hereby incorporated by reference.

### BACKGROUND

1. Technical Field

The present disclosure generally relates to vending machines, and particularly relates to a dispensing mechanism of a vending machine.

2. Description of Related Art

Vending machines have been in common use for purchasing a variety of items such as snacks, beverages, alcohol, cigarettes, lottery tickets, cologne, consumer products and even gold and gems. A vending machine typically includes a dispensing mechanism for dispensing items to customers after the customers insert currency or credit into the vending machines. However, the conventional dispensing mechanism is inflexible and is not able to handle increasing demands.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a dispensing mechanism of a vending machine.

FIG. 2 is an assembled view of the dispensing mechanism of FIG. 1.

FIG. 3 is similar to FIG. 2, showing the dispensing mechanism loaded with items.

FIG. 4 is a cross-sectional view of the dispensing mechanism of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

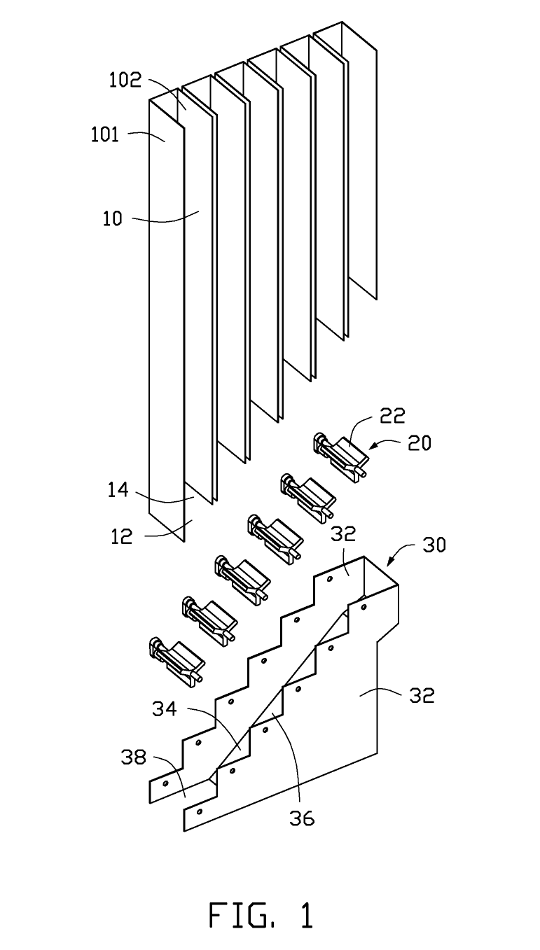

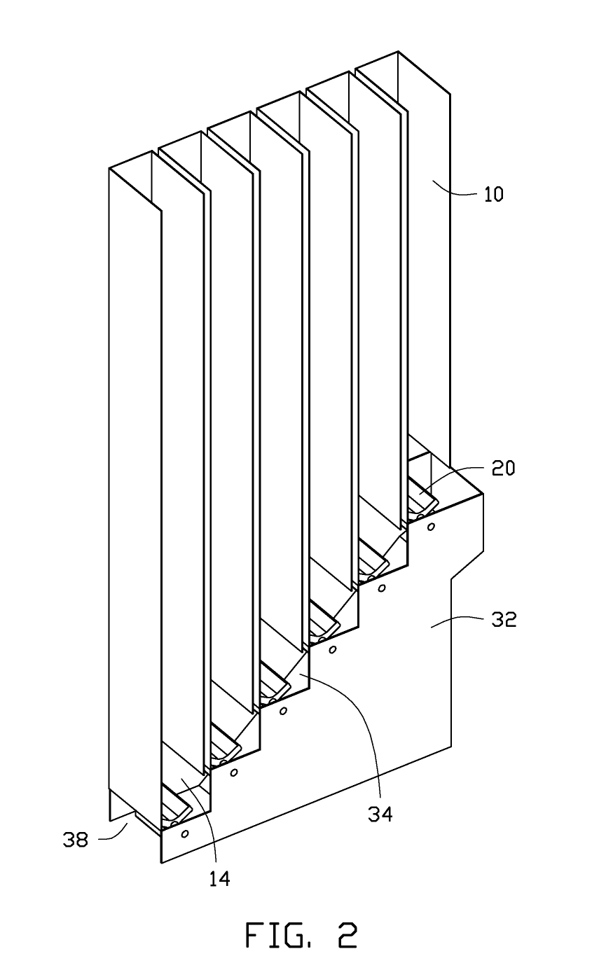

FIGS. 1 and 2 show an embodiment of a dispensing mechanism of a vending machine. The dispensing machine includes a plurality of containers 10, a plurality of rotary baffles 20, and a supporting member 30.

The container 10 includes a first side plate 101 and a second side plate 102.

The second side plate 102 is parallel to the first side plate 101. The second side plate 102 together with the first side plate 101 defines a vertical space for accommodating items. A distance between the first side plate 101 and the second side plate 102 is substantially the same as a width of a item. The length of the second side plate 102 is smaller than that of the first side plate 101.

The container 10 defines a bottom opening 12 and a lateral opening 14. The lateral opening 14 communicates with the bottom opening 12. The height of the lateral opening 14 is substantially the same as a vertical height of a item.

The rotary baffle 20 is located at the bottom opening 12 and blocks the bottom opening 14. The rotary baffle 20 is rotatable about a horizontal axis. The rotary baffle 20 defines a plurality of latching slots 22. Each of the plurality of latching slots 22 forms the shape of a V.

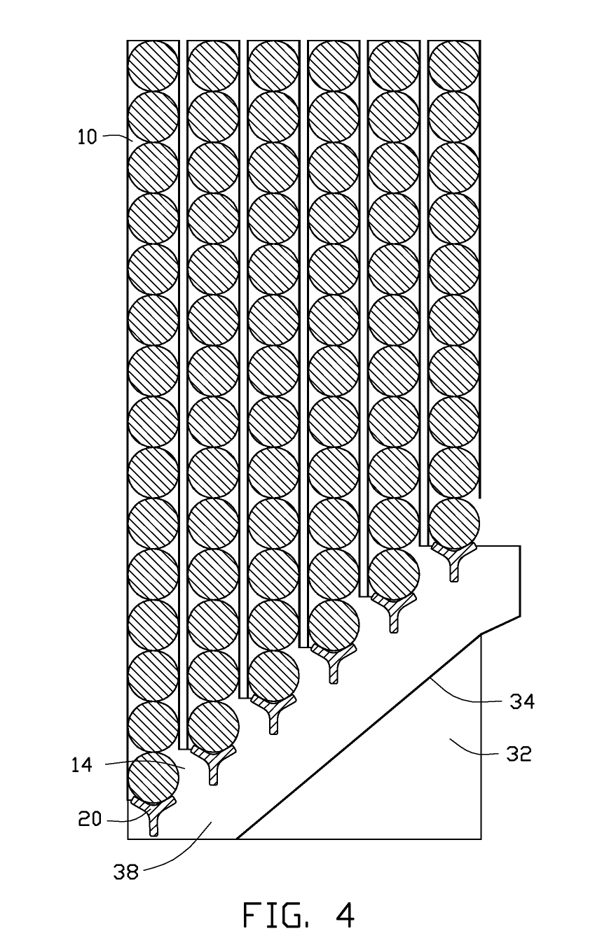

In one embodiment, as shown in FIG. 4, a cross section of the rotary baffle 20 is Y-shaped. The interior angle of each latching slot is then 120 degrees.

The supporting member 30 is beneath the plurality of containers 20. The supporting member 30 includes a two supporting plates 32 and a slanted plate 34. The slanted plate 34 is connected to the two supporting plates 32. The two supporting plates 32 are parallel to each other. The slanted plate 34 is slanted relative to the horizontal plane. The slanted plate 34 together with the pair of supporting plates 32 defines a guiding groove 36. The guiding groove 36 is slanted relative to the horizontal plane. The plurality of rotary baffles 20 is rotatably mounted to the two supporting plates 32. The two supporting plates 32 support a bottom edge of the first side plate 101 and a bottom edge of the second side plate 102 of each container 10.

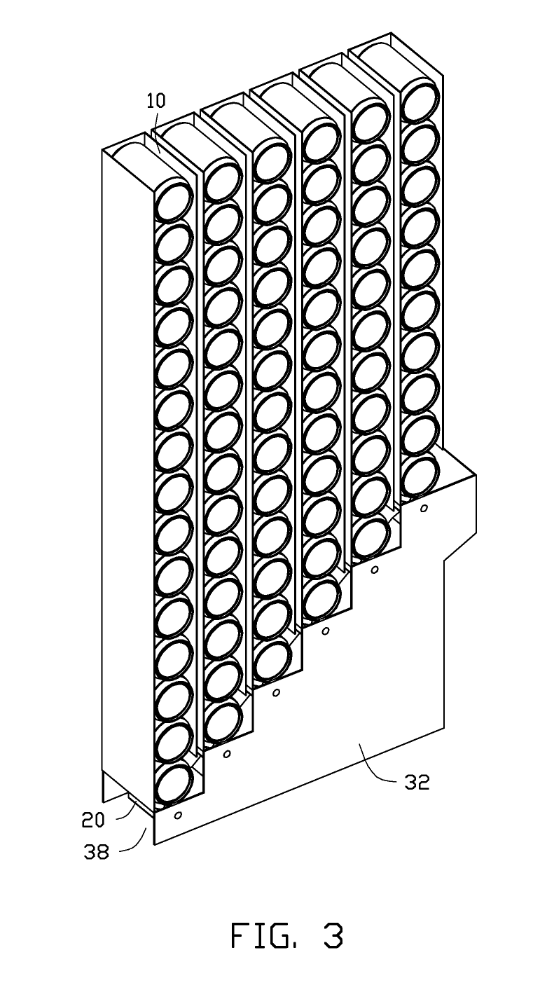

FIGS. 3 and 4 show that, in use, the dispensing mechanism is loaded with items (e.g., packaged beverages). Each container 10 stores a vertical stack of items. When the rotary baffle 20 is at rest, one of the plurality of latching slots 22 receives and supports a item and thereby prevents the items from dropping out of the container 10. When the rotary baffle 20 rotates a predetermined angle (e.g. 120 degrees), the rotary baffle 20 drives one item to move out of the lateral opening 14 and drop into the guiding groove 36. When a item drops into the guiding groove 36, the guiding groove 36 guides the dropped item to a delivery port 38 by gravity.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A dispensing mechanism of a vending machine, comprising:
a container configured for storing a stack of items vertically, the container defining a bottom opening and a lateral opening communicating with the bottom opening; and
a rotary baffle located at the bottom opening and configured to block the bottom opening, the rotary baffle being rotatable about a horizontal axis;
wherein when the rotary baffle is at rest, the rotary baffle supports the items and prevents the items from dropping out of the container, when the rotary baffle rotates a predetermined angle, the rotary baffle drives one of the items to move out of the lateral opening.

2. The dispensing mechanism of claim 1, wherein the container comprises a first side plate and a second side plate parallel to the first side plate, the second side plate and the first side plate cooperatively define a vertical space configured for accommodating the items vertically.

3. The dispensing mechanism of claim 2, wherein a length of the first side plate is greater than a length of the second side plate.

4. The dispensing mechanism of claim 3, wherein the rotary baffle defines a plurality of latching slots, when the rotary baffle is at rest, one of the plurality of latching slots receives one of the items and prevents the item from moving out of the lateral opening.

5. The dispensing mechanism of claim 4, wherein a cross section of each of the plurality of latching slots is V-shaped.

6. The dispensing mechanism of claim 5, wherein a cross section of the rotary baffle is Y-shaped, when the rotary baffle rotates 120 degrees, the rotary baffle drives one of the items to move out of the lateral opening.

7. The dispensing mechanism of claim 6, further comprising a supporting member beneath the container, wherein the supporting member defines a guiding groove, when one of the items is being moved out of the lateral opening, the item drops into the guiding groove, the guiding groove is configured to guide the item to a delivery port.

8. The dispensing mechanism of claim 7, wherein the guiding groove is slanted relative a horizontal plane.

9. The dispensing mechanism of claim 8, wherein the supporting member further comprises a pair of supporting plates, the rotary baffle is rotatably mounted to the pair of supporting plates.

10. The dispensing mechanism of claim 9, wherein the pair of supporting plates support a bottom edge of the first side plate and a bottom edge of the second side plate, respectively.

11. The dispensing mechanism of claim 10, wherein the supporting member further comprises a slanted plate connected to the pair of supporting plates, the slanted plate and the pair of supporting plates cooperatively define the guiding groove.

12. A dispensing mechanism of a vending machine, comprising:
a plurality of containers arranged side by side, wherein each of the plurality of containers is configured to store a stack of items vertically, each of the plurality of containers defines a bottom opening and a lateral opening communicating with the bottom opening; and
a plurality of a rotary baffles, wherein each of the plurality of rotary baffles is located at the bottom opening of one of the plurality of containers and configured to block the bottom opening, each of the plurality of rotary baffles is rotatable about a horizontal axis;
wherein when one of the plurality of rotary baffles is at rest, the plurality of rotary baffles support the items in each of the plurality of containers and prevent the items from dropping out of the container, when one of the plurality of rotary baffles rotates a predetermined angle, the rotary baffle drives one of the items in the container to move out of the lateral opening.

13. The dispensing mechanism of claim 12, wherein each of the plurality of containers comprises a first side plate and a second side plate parallel to the first side plate, the second side plate and the first side plate cooperatively define a vertical space configured for accommodating the items vertically.

14. The dispensing mechanism of claim 13, wherein a length of the first side plate is greater than a length of the second side plate.

15. The dispensing mechanism of claim 14, wherein each of the plurality of rotary baffles defines a plurality of latching slots, when the rotary baffle is at rest, one of the plurality of latching slots receives one of the items and prevents the items from moving out of the lateral opening.

16. The dispensing mechanism of claim 15, wherein a cross section of each of the plurality of latching slots is V-shaped.

17. The dispensing mechanism of claim 16, wherein a cross section of each of the plurality of rotary baffles is Y-shaped, when each of the rotary baffles rotates 120 degrees, the rotary baffle drives one item to move out of the lateral opening.

18. The dispensing mechanism of claim 17, further comprising a supporting member defining a guiding groove beneath the plurality of containers, wherein when one of the items drops out of one of the plurality of containers, the item drops into the guiding groove, the guiding groove is configured to guide the item to a delivery port.

19. The dispensing mechanism of claim 18, wherein the guiding groove is slanted relative a horizontal plane.

20. The dispensing mechanism of claim 19, wherein the supporting member further comprises a pair of supporting plates, the plurality of rotary baffles are rotatably mounted to each of the pair of supporting plates, and the pair of supporting plates support a bottom edge of the first side plate and a bottom edge of the second side plate of each of the plurality of containers, respectively.
